(19) United States
(12) Patent Application Publication
(10) Pub. No.: US 2025/0091370 A1
(43) Pub. Date: Mar. 20, 2025

(54) TRANSPORT DEVICE AND RECORDING DEVICE

(71) Applicant: SEIKO EPSON CORPORATION, Tokyo (JP)

(72) Inventor: Ryosuke BAN, SHIOJIRI-SHI (JP)

(21) Appl. No.: 18/889,123

(22) Filed: Sep. 18, 2024

(30) Foreign Application Priority Data
Sep. 20, 2023 (JP) 2023-152402

(51) Int. Cl. B41J 15/04

(52) U.S. Cl. CPC B41J 15/048; B41J 15/046

(57) ABSTRACT

A transport device 1 is provided with a holding section 80 capable of rotatably holding a plurality of roll bodies R, and a transport section 20 for transporting a medium M fed from the holding section 80, wherein the roll bodies R are configured to rotate in the holding section 80 as the medium M being fed out from the holding section 80 to the transport section 20 is transported by the transport section 20, and a friction force applying section 30 is provided for applying a frictional force against each medium M being fed out from the holding section 80 to the transport section 20.

The present application is based on, and claims priority from JP Application Serial Number 2023-152402, filed Sep. 20, 2023, the disclosure of which is hereby incorporated by reference herein in its entirety.

### BACKGROUND

### 1. Technical Field

The present disclosure relates to a transport device and a recording device.

### 2. Related Art

In the related art, various transport devices are being used. Among them, there is a transport device including a holding section configured to rotatably hold a plurality of roll bodies around which a medium is wound in a roll shape and a transport section that transports the medium fed out from the holding section. For example, a printing apparatus disclosed in JP-2018-134793 is provided with a feed-out section capable of holding a plurality of roll bodies and with a transport section for transporting roll paper fed from the feed-out section.

The printing apparatus is provided with a tension-applying section for individually applying, to a plurality of roll papers, tension against a transport force applied to the roll papers by the transport section. The tension applying portion includes a first motor and a second motor as a drive section for rotationally driving the roll bodies in the feed-out section. However, in the printing apparatus of JP-2018-134793, since the same number of drive sections are needed as the number of roll bodies, the configuration becomes complicated and costs become high. On the other hand, in the case where no drive sections are provided, a complicated mechanism for adjusting tension applied to each medium corresponding to the roll bodies having different diameters and made of different materials is generally required. As described above, in the related-art transport device equipped with the holding section and the transport section capable of rotatably holding multiple roll bodies, it is difficult to suitably transport the medium of each of the plurality of roll bodies with a simple configuration.

### SUMMARY

A transport device of the present disclosure for overcoming the above-described problem includes a holding section configured to rotatably hold a plurality of roll bodies around which medium is wound in a roll shape and a transport section that includes a drive section and that, by the drive force of the drive section, transports the medium fed out from the holding section, wherein the transport device is configured so that in the holding section, the roll bodies rotate in accordance with transport by the transport section of the medium being fed out from the holding section to the transport section and a friction force applying section is provided for applying a frictional force that resists against feed of the medium with respect to each medium being fed out from the holding section to the transport section.

### BRIEF DESCRIPTION OF THE DRAWINGS

FIG. 1 is a schematic side view of a recording device according to a first embodiment of the present disclosure.

FIG. 2 is a schematic view showing a holding shaft and a friction force applying section of the recording device of FIG. 1.

FIG. 3 is a schematic view showing a guide section of the recording device of FIG. 1.

FIG. 4 is a schematic diagram showing a holding shaft and a friction force applying section of a recording device according to a second embodiment of the present disclosure.

FIG. 5 is a schematic diagram showing a holding shaft and a friction force applying section of a recording device according to a third embodiment of the present disclosure.

FIG. 6 is a schematic diagram showing a holding shaft and a friction force applying section of a recording device according to a fourth embodiment of the present disclosure.

FIG. 7 is a schematic side view of a recording device according to a fifth embodiment of the present disclosure.

FIG. 8 is a schematic side view of a recording device according to a sixth embodiment of the present disclosure.

### DESCRIPTION OF EMBODIMENTS

First, the present disclosure will be schematically described.

A transport device according to a first aspect of the present disclosure for overcoming the above-described problems includes a holding section configured to rotatably hold a plurality of roll bodies around which medium is wound in a roll shape and a transport section that includes a drive section and that, by the drive force of the drive section, transports the medium fed out from the holding section, wherein the transport device is configured so that in the holding section, the roll bodies rotate in accordance with transport by the transport section of the medium being fed out from the holding section to the transport section and a friction force applying section is provided for applying a frictional force that resists against feed of the medium with respect to each medium being fed out from the holding section to the transport section.

According to this aspect, the transport device is configured so that in the holding section, the roll bodies rotate in accordance with transport by the transport section of the medium being fed out from the holding section to the transport section and a friction force applying section is provided for applying a frictional force that resists against feed of the medium with respect to each medium being fed out from the holding section to the transport section. That is, it is possible to apply tension to each medium fed out from the holding section to the transport section by using a mechanism for adjusting the tension applied to the medium as a friction force applying section with a simple structure without the need for a number of drive sections corresponding to the number of roll bodies. Therefore, the medium of each of the plurality of roll bodies can be suitably transported with a simple configuration.

A transport device of a second aspect of the present disclosure is an aspect according to the first aspect, wherein the friction force applying section is a weight.

According to this aspect, the friction force applying section is a weight. With such a configuration, the friction force applying section can have a particularly simple configuration.

A transport device of a third aspect of the present disclosure is an aspect according to the second aspect, wherein the holding section has a holding shaft for holding the roll bodies, an outer peripheral bearing for supporting an outer peripheral surface of the roll bodies is provided below the holding shaft, and the weight is connected to the holding shaft.

According to this aspect, an outer peripheral bearing for supporting an outer peripheral surface of the roll bodies is provided below the holding shaft, and the weight is connected to the holding shaft. According to such a configuration, the friction force applying section can have a particularly simple configuration, and in addition to this, tension can be suitably applied to each medium fed out from the holding section to the transport section.

A transport device of a fourth aspect of the present disclosure is an aspect according to the first aspect, wherein the friction force applying section is a spring.

According to this aspect, the friction force applying section is a spring. With such a configuration, the friction force applying section can have a particularly simple configuration.

A transport device of a fifth aspect of the present disclosure is an aspect according to the fourth aspect, wherein the holding section has a holding shaft for holding the roll bodies, an outer peripheral bearing for supporting the outer peripheral surface of the roll body is provided, and the spring is connected to the holding shaft in an arrangement such that the holding shaft is pressed in a direction in which the holding shaft approaches the outer peripheral bearing.

According to this aspect, the holding section has a holding shaft for holding the roll bodies, an outer peripheral bearing for supporting the outer peripheral surface of the roll body is provided, and the spring is connected to the holding shaft in an arrangement such that the holding shaft is pressed in a direction in which the holding shaft approaches the outer peripheral bearing. According to such a configuration, the friction force applying section can have a particularly simple configuration, and in addition to this, tension can be suitably applied to each medium fed out from the holding section to the transport section.

A transport device of a sixth aspect of the present disclosure is an aspect according to the fourth aspect, wherein the holding section has a holding shaft for holding the roll bodies, an outer peripheral bearing for supporting the outer peripheral surface of the roll body is provided, and the spring is provided on the outer peripheral bearing in an arrangement that presses the outer peripheral bearing in a direction in which the outer peripheral bearing approaches the holding shaft.

According to this aspect, the holding section has a holding shaft for holding the roll bodies, an outer peripheral bearing for supporting the outer peripheral surface of the roll body is provided, and the spring is provided on the outer peripheral bearing in an arrangement that presses the outer peripheral bearing in a direction in which the outer peripheral bearing approaches the holding shaft. According to such a configuration, the friction force applying section can have a particularly simple configuration, and in addition to this, tension can be suitably applied to each medium fed out from the holding section to the transport section.

A transport device of a seventh aspect of the present disclosure is an aspect according to the first aspect, further including an outer peripheral bearing for supporting the outer peripheral surface of the roll body is provided, and the friction force applying section is configured such that the outer peripheral bearing is arranged in a direction in which the roll bodies are pulled as the medium fed to the transport section is transported by the transport section.

According to this aspect, an outer peripheral bearing for supporting the outer peripheral surface of the roll body is provided, and the friction force applying section is configured such that the outer peripheral bearing is arranged in a direction in which the roll bodies are pulled as the medium fed to the transport section is transported by the transport section. According to such a configuration, the friction force applying section can have a particularly simple configuration, and in addition to this, tension can be suitably applied to each medium fed out from the holding section to the transport section.

A transport device of an eighth aspect of the present disclosure is an aspect according to the first aspect, wherein the holding section has a holding shaft for holding the roll bodies, the friction force applying section is a pressing section for pressing the roll bodies toward the holding shaft.

According to this aspect, the holding section has a holding shaft for holding the roll bodies, the friction force applying section is a pressing section for pressing the roll bodies toward the holding shaft. According to such a configuration, the friction force applying section can have a particularly simple configuration, and in addition to this, tension can be suitably applied to each medium fed out from the holding section to the transport section.

A transport device of a ninth aspect of the present disclosure is an aspect according to the first aspect, further including a guide section configured to guide the medium fed out from the holding section to the transport section.

According to this aspect, a guide section configured to guide the medium fed out from the holding section to the transport section. Therefore, the medium can be suitably fed out from the holding section to the transport section.

A recording device according to a tenth aspect of the present disclosure includes a transport device according to any one of the first to the ninth and a recording section configured to perform recording on a medium transported by the transport section.

According to this aspect, recording is performed on the medium transported by the transport section of the transport device. Therefore, recording can be performed on the medium which has been suitably transported.

### First Embodiment

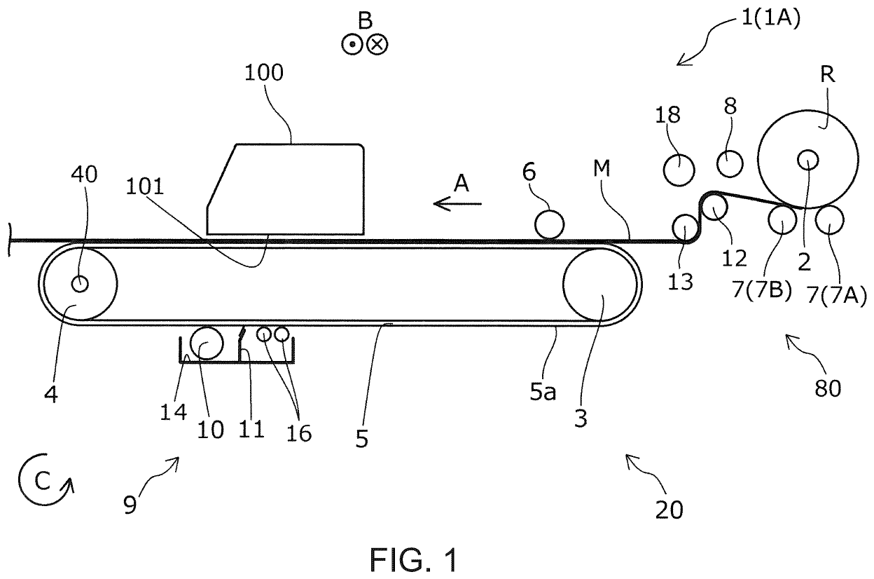

Hereinafter, embodiments according to the present disclosure will be described with reference to the accompanying drawings. First, the outline of a recording device 1A according to the first embodiment, which is both a transport device 1 and a recording device 1 of the present disclosure, will be described mainly with reference to FIG. 1. Here, recording devices 1 of a first embodiment to sixth embodiments are configured to be capable of using a plurality of roll bodies R at the same time. That is, they are configured so that it is possible to set a plurality of roll bodies R having different diameters, simultaneously transport the medium M from each roll body R, and simultaneously perform recording on each medium M.

As shown in FIG. 1, the recording device 1A of the present embodiment is provided with a holding section 80 capable of rotatably holding roll bodies R around which medium M is wound in a roll shape, and a transport section 20 that has a drive section 40, which is a motor, and that, by the driving force of the drive section 40, transports the medium M fed out from the holding section 80 in the transport direction A.

The holding section 80 is provided with a holding shaft 2 for holding the roll bodies R through which pass paper tubes, which constitute rotating shafts of the roll bodies R, a roller pair 7 serving as an outer peripheral bearing for supporting the roll bodies R from the outside, a roller 12, and a roller 13. The roller pair 7 is composed of two rollers 7A and 7B and is configured so that the roll bodies R can be supported from the outside by the two rollers 7A and 7B. Here, the holding shaft 2 can hold the roll body R through the paper tubes of the roll body R around which the medium M is wound in a roll shape. Also, the holding shaft 2 itself rotates in accordance with rotation of the roll bodies R. However, as a configuration in which the holding shaft 2 itself does not rotate, a configuration in which the paper tube of the roll bodies R slides while rotating with respect to the holding shaft 2 may be employed.

The holding section 80 is further provided with a roller 8 and a roller 18, and is configured to be a transport path from the roller 7B to the roller 12 via the roller 8, and to be a transport path from the roller 12 to the roller 13 via the roller 18. Note that the roller 18 is configured capable of functioning as a so-called tension generating roller capable of applying tension to the medium M while the medium M is being transported.

More specifically, although the roller 18 is rotated by the driving force of a motor (not shown), by the roller 18 rotating, the transport speed at which the medium Mis transported by the roller 18 is slower than the transport speed of the medium M supported on and transported by the transport belt 5, which constitutes the transport section 20. By rotating the roller 18 in this manner, the medium M is applied with tension in the transport direction A between the roller 18 and the transport belt 5, and is supported by the transport belt 5 in a state where tension is applied in the transport direction A. The recording device 1A of this embodiment is provided with a pressure roller 6 for pressing the medium M against the transport belt 5 in a region opposed to the transport belt 5. However, the roller 18 and the pressure roller 6 may not be provided.

The transport section 20 has a driven roller 3 located on the upstream side of the transport direction A, a drive roller 4 located on the downstream side of the transport direction A, and a transport belt 5, which is an endless belt, wound around the driven roller 3 and the drive roller 4. Here, the transport belt 5 is an adhesive belt having an outer peripheral surface 5a whose support surface, which is the outer surface, for the medium M is coated with an adhesive.

As shown in FIG. 1, the medium M is supported on and transported by the transport belt 5 in a state in which the medium M clings to the outer peripheral surface 5a of the transport belt 5. In recording device 1A of this embodiment, a medium supporting region where the transport belt 5 supports the medium M is an upper region spanning between the driven roller 3 and the drive roller 4. The drive roller 4 is a roller rotated in a rotation direction C by drive force of the drive section 40, which is a motor, and the driven roller 3 is a roller rotated by being driven by the rotation of the transport belt 5 that accompanies rotation of the drive roller 4.

The recording device 1A of the present embodiment includes a carriage 100 capable of reciprocating in the width direction B of the transport belt 5, and a head 101 attached to the carriage 100. The head 101 is a recording section capable of recording, based on the recording data, an image by ejecting liquid ink onto the medium M transported in the transport direction A.

The recording device 1A of the present embodiment can form an image by ejecting ink from the head 101 onto the medium M being transported while reciprocating the carriage 100 in the width direction B, which intersects the transport direction A. By providing the carriage 100 with such a configuration, the recording device 1A of the present embodiment can form a desired image on the medium M by repeating the transport of the medium M in the transport direction Aby a predetermined transport amount and, while the medium Mis stopped, ejecting ink while moving the carriage 100 in the width direction B.

As described above, the recording device 1A of the present embodiment includes a so-called serial head type ejection head in which the head 101 mounted on the carriage 100 reciprocates in the width direction B. However, it is not limited to such an ejection head. For example, the head 101 may be a line head type recording section that extends in the width direction B and is fixed in place, and in which are arrayed a plurality of nozzles that eject ink along the width direction B. Note that in the case of the configuration including a line head type recording section, the medium M can be transported by so-called continuous transport in which the medium M is continuously transported, instead of transport of the medium M by so-called intermittent transport as in the recording device 1A of the present embodiment, wherein transport of the medium M by a predetermined transport amount and stoppage of the medium M are repeated.

When the medium M on which an image was formed by ejecting ink from the head 101 is discharged from the recording device 1A of the present embodiment, the medium M is sent to a drying device for volatilizing a component of the ink ejected onto the medium M, a winding device for winding up the medium M on which an image was formed, and the like, which are provided in stages subsequent to the recording device 1A of the present embodiment.

Here, as the medium M, a textile print material can be desirably used. Textile print material refers to fabrics, clothes, other apparel products that are the target of printing. Fabric includes woven, knitted, and non-woven fabrics made of natural fibers such as cotton, silk, and wool, chemical fibers such as nylon, or composite fibers in which these fibers are mixed. Clothing and other apparel products include sewn T-shirts, handkerchiefs, scarves, towels, carrier bags, fabric bags, curtains, sheets, covers for beds or other furniture, as well as pre-cut and post-cut fabrics that exist as pre-sewn parts. However, in addition to the above-mentioned textile print material to be printed on, specialized paper for ink jet recording such as plain paper, wood-free paper, and glossy paper can also be used.

When a textile print material is used as the medium M, the ink ejected onto the medium M tends to seep through the back side of the textile print material, which is a phenomenon of ink bleeding to the back side, and the transport belt 5 may become stained with ink. Therefore, the recording device 1A of the present embodiment is provided with a washing section 9 for cleaning the ink that passed through and adhered to the transport belt 5. The washing section 9 of this embodiment is provided with a storage tank 14 for storing a cleaning liquid, a washing roller 10 immersed in the cleaning liquid and in contact with the transport belt 5, a blade 11 for wiping the cleaning liquid clinging to the transport belt 5, and an absorption roller 16 for absorbing the cleaning liquid left unwiped by the blade 11.

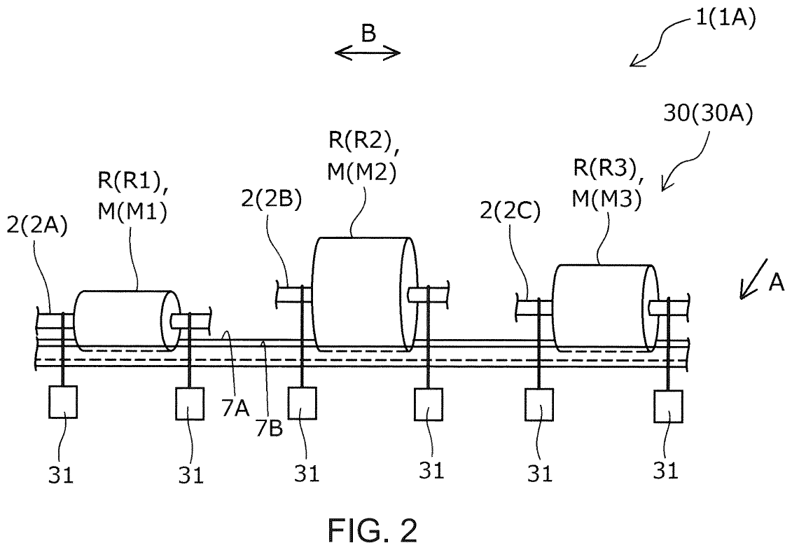

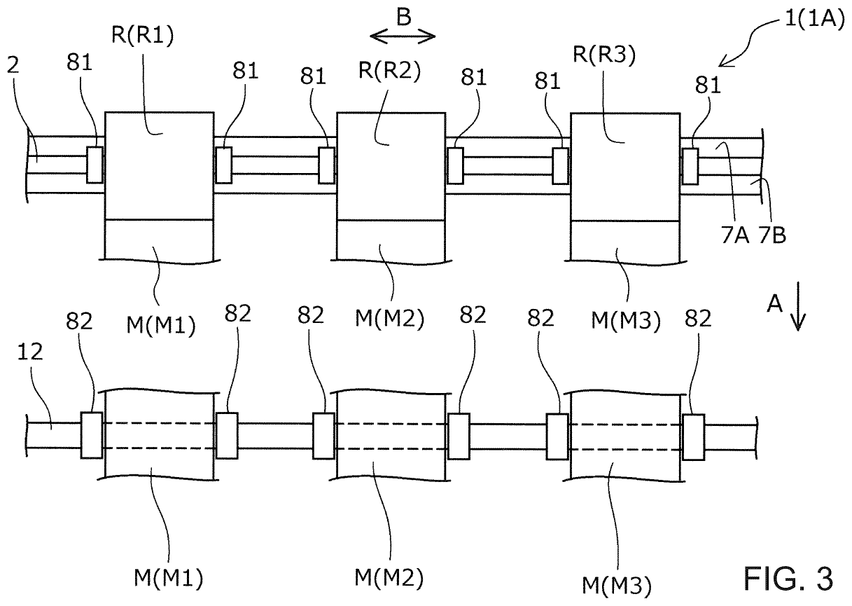

Next, the holding section 80, which is a main part of the recording device 1A of this embodiment, will be described in detail with reference to FIGS. 2 and 3 in addition to FIG. 1. Here, the holding section 80 of recording device 1A of the present embodiment is configured such that the roll bodies R rotate in the holding section 80 along with transport, by transport section 20, of the medium M that is being fed out from the holding section 80 to the transport section 20. That is, no drive section such as a motor is connected to the holding shaft 2, and the holding shaft 2 is configured to be capable of being driven and rotated by rotation of the roll bodies R as the medium M is transported by the transport section 20. As shown in FIG. 3, the holding shaft 2 of recording device 1A of this embodiment is configured to be able to hold a plurality of roll bodies R arranged in the width direction B.

As in recording device 1A of the present embodiment, in a configuration in which the holding shaft 2 rotates in response to rotation of the roll bodies R, the tension along the transport direction A may be insufficient against the medium M being fed out from the holding section 80 to the transport section 20. If the tension along the transport direction A becomes insufficient, then the medium M may not stick properly to the outer peripheral surface 5a of the transport belt 5. Therefore, as shown in FIG. 2, the recording device 1A of this embodiment is provided with a friction force applying section 30A. In other words, recording device 1A of this embodiment is provided with a friction force applying section 30 that applies a frictional force that resists against feed of the medium M, to each medium M being fed out from the holding section 80 to the transport section 20, in other words, to each medium M of the plurality of roll bodies R held on the holding shaft 2. By applying a frictional force that resists against transport of the medium M, a desired tension can be applied to the medium M being fed out from the holding section 80 to the transport section 20.

As described above, the recording device 1A of the present embodiment is configured such that the roll bodies R are rotated in the holding section 80 as the transport section 20 transports the medium M being fed out from the holding section 80 to the transport section 20, and the recording device 1A is provided with a friction force applying section 30A for applying a frictional force that resists against feed of the medium M, to each medium M being fed out from the holding section 80 to the transport section 20. That is, the recording device 1A of the present embodiment can hold a plurality of roll bodies R on the holding shaft 2, does not require the same number of drive sections as the number of roll bodies R, uses a mechanism for adjusting the tension applied to the medium M as the friction force applying section 30 having a simple structure, and can apply tension to each medium M being fed out from the holding section 80 to the transport section 20. Therefore, the recording device 1A of this embodiment can suitably transport the medium M of each roll body R with a simple configuration.

Note that as described above, the recording device 1A of the present embodiment includes the head 101 as a recording section capable of performing recording on the medium M transported by the transport section 20. In other words, recording is performed on the medium M transported by the transport section 20. Therefore, recording device 1A of the present embodiment can perform recording on the medium M that has been suitably transported.

As shown in FIG. 2, the friction force applying section 30A in the recording device 1A of this embodiment is weights 31 provided on the holding shaft 2. By providing the holding shaft 2 with the weights 31, the roll bodies Rare pressed against the rollers 7A and 7B and a frictional force resisting against feed of the medium M is applied. In this way, by using weights 31 as the friction force applying section 30, the friction force applying section 30 can have a particularly simple configuration.

As shown in FIG. 2, the recording device 1A of this embodiment has, as the holding shaft 2, a holding shaft 2A, a holding shaft 2B, and a holding shaft 2C, and can hold a roll body R1 around which a medium M1 is wound, a roll body R2 around which a medium M2 is wound, and a roll body R3 around which a medium M3 is wound. Since each of the holding shaft 2A, the holding shaft 2B, and the holding shaft 2C is provided with weights 31, the roll body R1, the roll body R2, and the roll body R3 can each be pressed against the rollers 7A and 7B.

As described above, the recording device 1A of the present embodiment has, as the holding section 80, the holding shaft 2 that holds the roll bodies R and, as the outer peripheral bearing, the roller pair 7 (the rollers 7A and 7B) that support the outer peripheral surface of the roll bodies R and that is provided below the holding shaft 2. As described above, the weights 31 are connected to the holding shaft 2. By adopting such a configuration, the recording device 1A of the present embodiment can appropriately apply tension to each medium M being fed out from the holding section 80 to the transport section 20 while making the friction force applying section 30 particularly simple in configuration.

As shown in FIG. 3, the recording device 1A of this embodiment is provided with a guide section 81 for restricting movement of the roll bodies R in the width direction B in order to suppress skew transport of the medium M, and a guide section 82 provided in the transport path of the medium M to suppress skew transport of the medium M. Thus, it is preferable to provide a guide section for guiding the medium M being fed out from the holding section 80 to the transport section 20. This is because the medium M can be suitably fed out from the holding section 80 to the transport section 20.

In the present embodiment, the guide sections are provided at two positions, that is, a position opposed to the rollers 7A and 7B and the position of the roller 12, and in the way it is particularly desirable that the guide sections are provided at a plurality of positions (two positions) in the transport direction A in order to suppress skew transport. However, it is not limited to such a configuration, and a configuration in which the guide section is provided at one location in the transport direction A may be employed or a configuration in which the guide section is provided at three or more locations in the transport direction A may be employed.

Although a plurality of roll bodies R having different diameters are set in this embodiment, a plurality of roll bodies R made of different materials may be set. For example, it is possible to adopt a configuration in which the coefficients of friction between roller 7A and roller 7B and each medium M being fed out from the plurality of roll bodies R are different from each other. Even in such a case, by providing the friction force applying section 30, it is possible to apply a desired tension to each medium M being fed out from the holding section 80 to the transport section 20.

### Second Embodiment

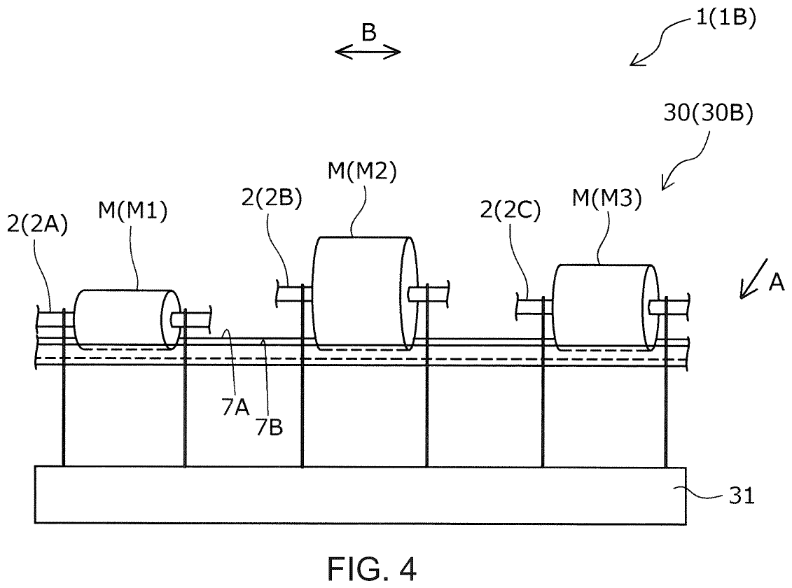

Next, a recording device 1B of the second embodiment will be described with reference to FIG. 4. FIG. 4 is a diagram corresponding to FIG. 2 of recording device 1A of the first embodiment. In FIG. 4, components common to those of the first embodiment are denoted by the same reference numerals, and detailed description thereof will be omitted. Here, the recording device 1B of the present embodiment has the same configuration as recording device 1A of the first embodiment, except for the configuration of the friction force applying section 30. Therefore, the recording device 1B of the present embodiment can also be regarded as indicated by FIGS. 1 and 3, and the recording device 1B of the present embodiment has the same features as the recording device 1A of the first embodiment, except for the parts described below.

As shown in FIG. 2, in the friction force applying section 30A of the recording device 1A of the first embodiment, two weights 31 are provided for each of the holding shaft 2A, the holding shaft 2B, and the holding shaft 2C. On the other hand, as shown in FIG. 4, in the friction force applying section 30B of the recording device 1B of this embodiment, one weight 31 is provided, and the weight 31 is connected to each of the holding shaft 2A, the holding shaft 2B, and the holding shaft 2C. As described above, the number of the weights and the method of connecting the weights to the holding shaft 2 are not particularly limited.

### Third Embodiment

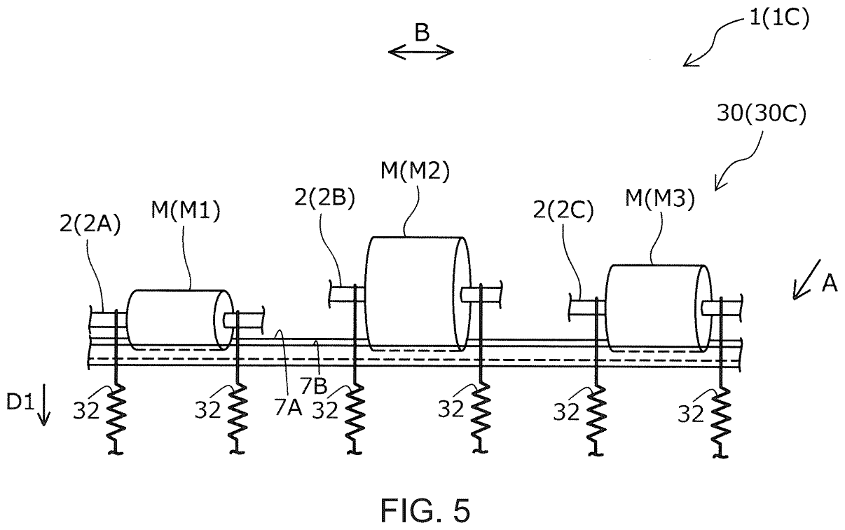

Next, a recording device 1C according to a third embodiment will be described with reference to FIG. 5. FIG. 5 is a diagram corresponding to FIG. 2 of recording device 1A of the first embodiment. In FIG. 5, components common to those of the first embodiment and the second embodiment are denoted by the same reference numerals, and detailed description thereof will be omitted. Here, the recording device 1C of this embodiment has the same configuration as the recording devices 1 of the first embodiment and of the second embodiment, except for the configuration of the friction force applying section 30. Therefore, the recording device 1C of the present embodiment can also be regarded as indicated by FIGS. 1 and 3, and the recording device 1C of the present embodiment has the same features as the recording devices 1 of the first embodiment and of the second embodiment, except for the parts described below.

As shown in FIGS. 2 and 4, the friction force applying section 30 of the recording devices 1 of the first embodiment and of the second embodiment is weights 31. On the other hand, as shown in FIG. 5, the friction force applying section 30C of the recording device 1C of this embodiment is springs 32. More specifically, two springs 32 are provided for each of the holding shaft 2A, the holding shaft 2B, and the holding shaft 2C, and the holding shaft 2A, the holding shaft 2B, and the holding shaft 2C are pressed toward the roller pair 7 (rollers 7A and 7B) by the spring force of the springs 32. In the recording device 1C of the present embodiment, the friction force applying section 30 has a particularly simple configuration by adopting such a configuration.

In other words, in the recording device 1C of this embodiment, the holding section 80 has the holding shaft 2 for holding the roll bodies R, and is provided with the roller pair 7 (rollers 7A and 7B), which is an outer peripheral bearing for supporting the outer peripheral surface of the roll bodies R. The springs 32 are connected to the holding shaft 2 and arranged so as to press the holding shaft 2 in a direction D1 in which the holding shaft 2 approaches the roller pair 7. By adopting such a configuration, the recording device 1C of the present embodiment can suitably apply tension to each medium M being fed out from the holding section 80 to transport section 20 while the friction force applying section 30 has a particularly simple configuration.

### Fourth Embodiment

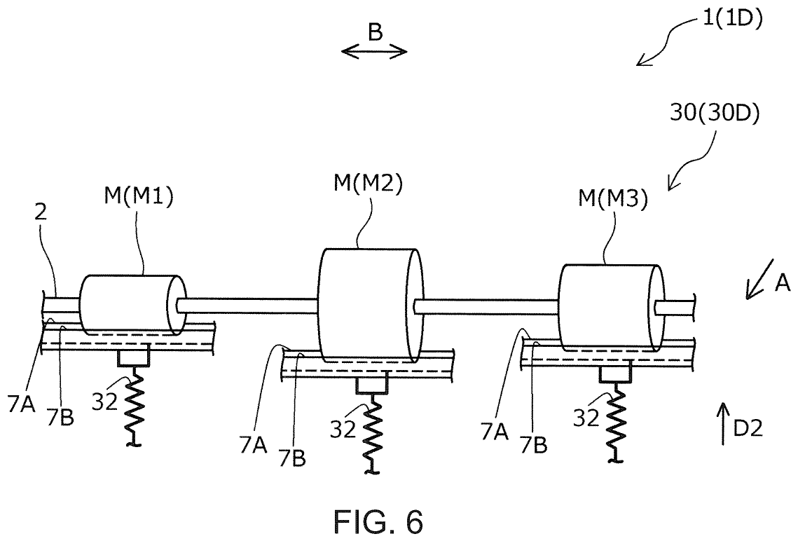

Next, a recording device 1D according to a fourth embodiment will be described with reference to FIG. 6. FIG. 6 is a diagram corresponding to FIG. 2 of the recording device 1A of the first embodiment. In FIG. 6, components common to those of the first embodiment to the third embodiment are denoted by the same reference numerals, and detailed description thereof will be omitted. Here, the recording device 1D of this embodiment has the same configuration as the recording devices 1 of the first embodiment to the third embodiment, except for the configuration of the friction force applying section 30. Therefore, the recording device 1D of the present embodiment can also be regarded as indicated by FIGS. 1 and 3, and the recording device 1D of the present embodiment has the same features as the recording devices 1 of the first embodiment to the third embodiment, except for the parts described below.

As shown in FIG. 5, the friction force applying section 30C of the recording device 1C of the third embodiment is a spring 32 connected to the holding shaft 2 in an arrangement that presses the holding shaft 2 in the direction D1 in which the holding shaft 2 approaches the roller pair 7. On the other hand, as shown in FIG. 6, the friction force applying section 30D of the recording device 1D of the present embodiment is springs 32 provided to the roller pair 7 (rollers 7A and 7B), which is an outer peripheral bearing, in an arrangement in which the roller pair 7 is pressed in a direction D2 in which the roller pair 7 approaches the holding shaft 2. With such a configuration, the friction force applying section 30 can be made particularly simple and, on top of this, tension can be suitably applied to each medium M being fed out from the holding section 80 to the transport section 20.

The recording devices 1 of the first embodiment to the third embodiment are configured so that the holding shaft 2 is divided in the width direction B and the position of the holding shaft 2 with respect to the roller pair 7 can be adjusted in order to accommodate a plurality of roll bodies R having different diameters when a plurality of roll bodies R are used at the same time. On the other hand, the recording device 1D of the present embodiment is configured so that the roller pair 7 (rollers 7A and 7B) is divided in the width direction B and the positions of the roller pair 7 with respect to the holding shaft 2 can be adjusted in order to handle a plurality of roll bodies R having different diameters when a plurality of roll bodies R are used at the same time. In the recording device 1C of the third embodiment and the recording device 1D of the present embodiment, a spring is used as the friction force applying section 30, but an elastic member such as a rubber member may be used instead of the spring.

### Fifth Embodiment

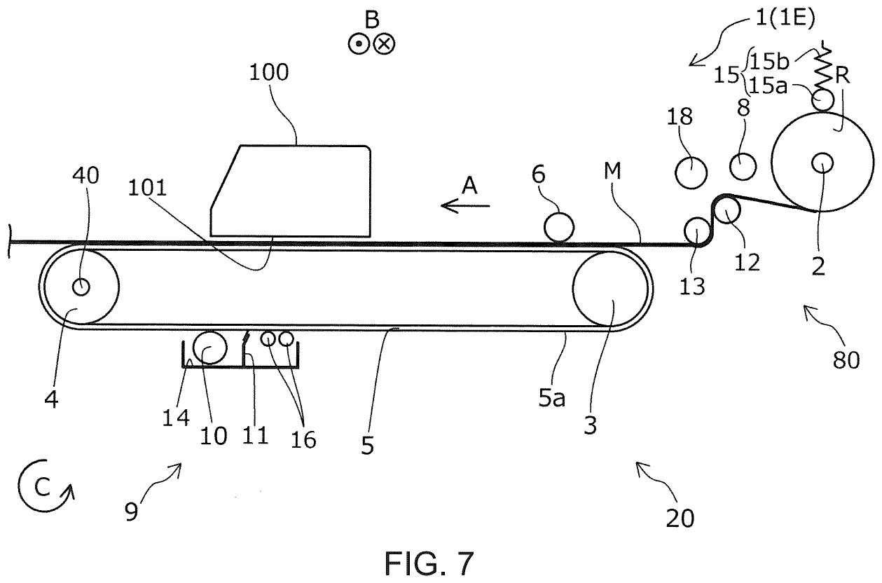

Next, recording device 1E according to a fifth embodiment will be described with reference to FIG. 7. FIG. 7 is a diagram corresponding to FIG. 1 of recording device 1A of the first embodiment. In FIG. 7, components common to those of the first embodiment to the fourth embodiment are denoted by the same reference numerals, and detailed description thereof will be omitted. Here, the recording device 1E of this embodiment has the same configuration as the recording devices 1 of the first embodiment to the fourth embodiment, except for the configuration of the friction force applying section 30. Therefore, the recording device 1E of the present embodiment can also be regarded as indicated by FIG. 3, and the recording device 1E of the present embodiment has the same features as the recording devices 1 of the first embodiment to the fourth embodiment, except for the parts described below.

As described above, the friction force applying section 30 of the recording devices 1 according to the first embodiment to the fourth embodiment are configured to apply tension to each medium M being fed out from the holding section 80 to the transport section 20 by pressing the roll bodies R and the roller pair 7, which serves as an outer peripheral bearing, against each other. On the other hand, as shown in FIG. 7, the friction force applying section 30 of the recording device 1E of the present embodiment is a pressing section 15 that has a roller section 15a in contact with the roll bodies R and a spring section 15b for pressing the roller section 15a against the roll bodies R and that is capable of pressing the roll bodies R toward the holding shaft 2. A frictional force is also applied by pressing the roll bodies R toward the holding shaft 2, and tension can be applied to each medium M being fed out from the holding section 80 to the transport section 20. With such a configuration, the friction force applying section 30 can be made particularly simple and, on top of this, tension can be suitably applied to each medium M being fed out from the holding section 80 to the transport section 20.

Note that as another example of a configuration that does not have an outer peripheral bearing as in recording device 1E of the present embodiment, instead of providing the pressing section 15 as the friction force applying section 30, the holding shaft 2 may be configured not to rotate together with rotation of the roll bodies R, and a high friction forming section, such as a configuration that spreads from the inside with respect to the paper tube of the roll bodies R, may be provided in the holding shaft 2, and the high friction forming section may be used as the friction force applying section 30. With such a configuration, the friction force applying section 30 can be made particularly simple and, on top of this, tension can be suitably applied to each medium M being fed out from the holding section 80 to the transport section 20.

### Sixth Embodiment

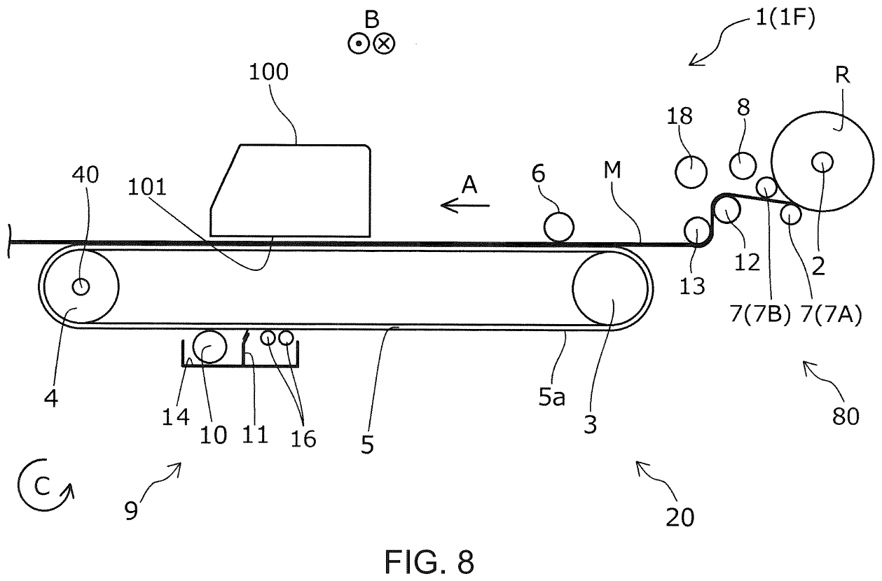

Next, a recording device 1F according to a sixth embodiment will be described with reference to FIG. 8. FIG. 8 is a diagram corresponding to FIG. 1 of the recording device 1A of the first embodiment. In FIG. 8, components common to those of the first embodiment to the fifth embodiment are denoted by the same reference numerals, and a detailed description thereof will be omitted. The recording device 1F of the present embodiment has the same configuration as the recording devices 1 of the first embodiment to fifth embodiment, except for the configuration of the friction force applying section 30. Therefore, the recording device 1F of the present embodiment can also be regarded as indicated by FIG. 3, and the recording device 1F of the present embodiment has the same features as those of the recording devices 1 of the first embodiment to the fifth embodiment, except for the parts described below.

As shown in FIG. 1, in the recording device 1A of the first embodiment, the roller pair 7, which is an outer peripheral bearing, is configured to support the roll bodies R from below in the vertical direction. On the other hand, as shown in FIG. 8, in the recording device 1F of the present embodiment, the roller pair 7, which is an outer peripheral bearing, is configured to support the roll bodies R from a position shifted from the vertical direction, more specifically, from a direction in which the roll bodies Rare pulled from the transport section 20 side as the transport section 20 transports the medium M.

From another viewpoint, the recording device 1F of the present embodiment is provided with a roller pair 7, which is an outer peripheral bearing for supporting the outer peripheral surface of the roll bodies R, and the friction force applying section 30 is configured such that the roller pair 7 is arranged in a direction in which the roll bodies R are pulled as the medium M being fed out to the transport section 20 is transported by the transport section 20. Even with such a configuration, a frictional force can be applied, and tension can be applied to each medium M being fed out from the holding section 80 to the transport section 20. Also, the friction force applying section 30 has a particularly simple structure and, on top of this, it is possible to suitably apply tension to each medium M being fed out from the holding section 80 to the transport section 20.

As shown in FIG. 8, in this embodiment, a configuration in which the roller pair 7 is arranged in a direction in which the roll bodies Rare pulled as the medium M being fed out to the transport section 20 is transported by the transport section 20 is formed by passing the medium M from between the rollers 7A and 7B, which constitute the roller pair 7. By adopting such a configuration, it is possible to easily form a configuration in which the roller pair 7 is arranged in a direction in which the roll bodies R are pulled as the medium M being fed out to the transport section 20 is transported by the transport section 20.

It should be noted that the present disclosure is not limited to the above-mentioned embodiments, and various modifications can be made within the scope of the disclosure described in the claims, and it goes without saying that these are also included within the scope of the present disclosure.

What is claimed is:

1. A transport device comprising:
a holding section configured to rotatably hold a plurality of roll bodies around which medium is wound in a roll shape and a transport section that includes a drive section and that, by the drive force of the drive section, transports the medium fed out from the holding section, wherein
the transport device is configured so that in the holding section, the roll bodies rotate in accordance with transport by the transport section of the medium being fed out from the holding section to the transport section and
a friction force applying section is provided for applying a frictional force that resists against feed of the medium with respect to each medium being fed out from the holding section to the transport section.

2. The transport device according to claim 1, wherein
the friction force applying section is a weight.

3. The transport device according to claim 2, wherein
the holding section has a holding shaft for holding the roll bodies,
an outer peripheral bearing for supporting an outer peripheral surface of the roll bodies is provided below the holding shaft, and
the weight is connected to the holding shaft.

4. The transport device according to claim 1, wherein
the friction force applying section is a spring.

5. The transport device according to claim 4, wherein
the holding section has a holding shaft for holding the roll bodies,
an outer peripheral bearing for supporting the outer peripheral surface of the roll body is provided, and
the spring is connected to the holding shaft in an arrangement such that the holding shaft is pressed in a direction in which the holding shaft approaches the outer peripheral bearing.

6. The transport device according to claim 4, wherein
the holding section has a holding shaft for holding the roll bodies,
an outer peripheral bearing for supporting the outer peripheral surface of the roll body is provided, and
the spring is provided on the outer peripheral bearing in an arrangement that presses the outer peripheral bearing in a direction in which the outer peripheral bearing approaches the holding shaft.

7. The transport device according to claim 1, wherein
an outer peripheral bearing for supporting the outer peripheral surface of the roll body is provided and
the friction force applying section is configured such that the outer peripheral bearing is arranged in a direction in which the roll bodies are pulled as the medium fed to the transport section is transported by the transport section.

8. The transport device according to claim 1, wherein
the holding section has a holding shaft for holding the roll bodies and
the friction force applying section is a pressing section for pressing the roll bodies toward the holding shaft.

9. The transport device according to claim 1, further comprising:
a guide section configured to guide the medium fed out from the holding section to the transport section.

10. A recording device comprising:
the transport device according to claim 1 and
a recording section configured to perform recording on a medium transported by the transport section.
